(19) United States
(12) Patent Application Publication
(10) Pub. No.: US 2026/0339932 A1
(43) Pub. Date: Oct. 29, 2026

(54) KNOWLEDGE GRAPH POWERED, AGENTIC AI GUIDED RETRIEVAL-AUGMENTED GENERATION

(71) Applicant: Palo Alto Networks, Inc., Santa Clara, CA (US)

(72) Inventors: Adithya Patham Shriram, San Jose, CA (US); Alok Tongaonkar, San Jose, CA (US); Richard Padilla, Margate, FL (US); Arpitha Hiresadrahalli Dayananda, San Jose, CA (US); Amrutha Bhargavi Rajkumar, Santa Clara, CA (US)

(21) Appl. No.: 19/192,598

(22) Filed: Apr. 29, 2025

(51) Int. Cl. G06F 16/242; G06F 16/36; G06F 16/383

(52) U.S. Cl. CPC G06F 16/2433; G06F 16/367; G06F 16/383

(57) ABSTRACT

An intelligent query augmentation agentic AI system leveraging a knowledge graph for one or more knowledge domains has been created. The knowledge graph has been built to indicate entities and relationships among those entities based on defined taxonomy and ontology. The agentic AI system includes an orchestrator and one or more additional AI agents. The orchestrator extracts entities from the received query and directs the AI agent(s) to obtain information about the extracted entities. The orchestrator interacts with a requestor-context AI agent that collects information on activities of the requestor. The orchestrator also interacts with an organization-context AI agent that searches data sources for information related to the extracted entities. The orchestrator queries the graph based on the collected information and a degree of relationship. The agentic AI system augments the received query with the graph structured data and communicates the query to a target AI model.

### BACKGROUND

The disclosure generally relates to computing arrangements based on specific computational models (e.g., CPC G06N) and electrical digital data processing related to handling natural language data (e.g., CPC G06F 40/00).

The Stanford Institute for Human-Centered Artificial Intelligence (“AI”) created an interdisciplinary initiative named the Center for Research on Foundation Models. They coined the term “foundation models” to refer to machine learning models “trained on broad data at scale such that they can be adapted to a wide range of downstream tasks.” Some models considered foundation models include BERT, GPT-4, Codex, and LLaMA. Foundation models are based on artificial neural networks including generative adversarial networks (“GANs”), transformers, and variational encoders. With the greater adoption of foundation models, the term artificial intelligence (AI) model is being used more often as a generic term.

Applications that use foundation models have combined the use of a foundation model with retrieval-augmented generation (RAG). RAG augments a query/prompt with embeddings to add context for improved accuracy of the result. The embeddings are retrieved from a knowledge base or curated data source external to the foundation model. This separation allows for knowledge to be more efficiently updated since the knowledge base is updated instead of the model itself and facilitates dynamic augmentation of a prompt with current context for a domain(s) represented by the knowledge base. The RAG technique generates an embedding(s) from the prompt and retrieves similar embeddings from the knowledge base. The paper that introduced the RAG framework is “Retrieval-Augmented Generation for Knowledge-Intensive NLP Tasks” published in NIPS′20: Proceedings of the 34th International Conference on Neural Information Processing Systems, December 2020.

### BRIEF DESCRIPTION OF THE DRAWINGS

Embodiments of the disclosure may be better understood by referencing the accompanying drawings.

FIG. 1 depicts an example diagram of a query being augmented by an agentic AI based RAG system.

FIG. 2 is a diagram of the agentic AI based RAG system retrieving information to augment an initial query and a subsequent query.

FIG. 3 is an example diagram of an AI model generating a knowledge graph to be used by an agentic AI based RAG system.

FIG. 4 is a flowchart of example operations to generate a knowledge graph with an AI model.

FIG. 5 is a flowchart of example operations to augment a query with graph structured context retrieved by an agentic AI based RAG system.

FIG. 6 is a flowchart of example operations to retrieve from a knowledge graph contextual information based on entities and entity types from the AI agents.

FIG. 7 is a flowchart of example operations to expand and constrain indications of entities and entity types from an AI agent based on a knowledge graph.

FIG. 8 depicts an example computer system with an agentic AI based RAG subsystem and a knowledge graph constructor.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### INTRODUCTION

AI agents are a form of AI that includes memory, a reasoning engine, and a tool or access to a tool. AI agent memory maintains a contextual history which allows the AI agent to remember and learn from previous tasks and results. The reasoning engine performs logical inference, planning, and contextual understanding for the AI agent. A tool of the AI agent allows the AI agent to interact with other systems to obtain information and/or extend functionality. A tool is an external resource that is used by an AI agent. Examples of tools include a knowledge base, Application Programming Interface (API), calendar, and search engine. Multi-AI agent systems or agentic AI systems decompose a complex task into subtasks delegated to the AI agents of the system to complete with little to no supervision.

### Overview

An intelligent and flexible prompt/query augmentation system has been created with an agentic AI system leveraging a knowledge graph for one or more knowledge domains. The knowledge graph has been built to indicate entities of the one or more knowledge domains and relationships among those entities based on defined taxonomy and ontology. The agentic AI system includes an AI agent that is an orchestrator and one or more additional AI agents. The orchestrator will retrieve graph structured data from the knowledge graph to augment a received query. To inform the retrieval of graph structured data, the orchestrator extracts entities from the received query and directs the one or more additional AI agents to obtain information about the extracted entities. This information includes additional entities related to the extracted entities and types of the entities. The orchestrator interacts with a requestor-context AI agent that collects information from data relating to queries and activity of the requestor corresponding to the received query. The orchestrator also interacts with an organization-context AI agent that searches or queries data sources for information related to the extracted entities. The orchestrator forms a query to the knowledge graph based on the collected information and a degree of relationship parameter, for example limiting the search of the knowledge graph to 2-degrees of separation of each entity. The agentic AI system augments the received query based on the graph structured data and the augmented query is passed to a target AI model.

### Example Illustrations

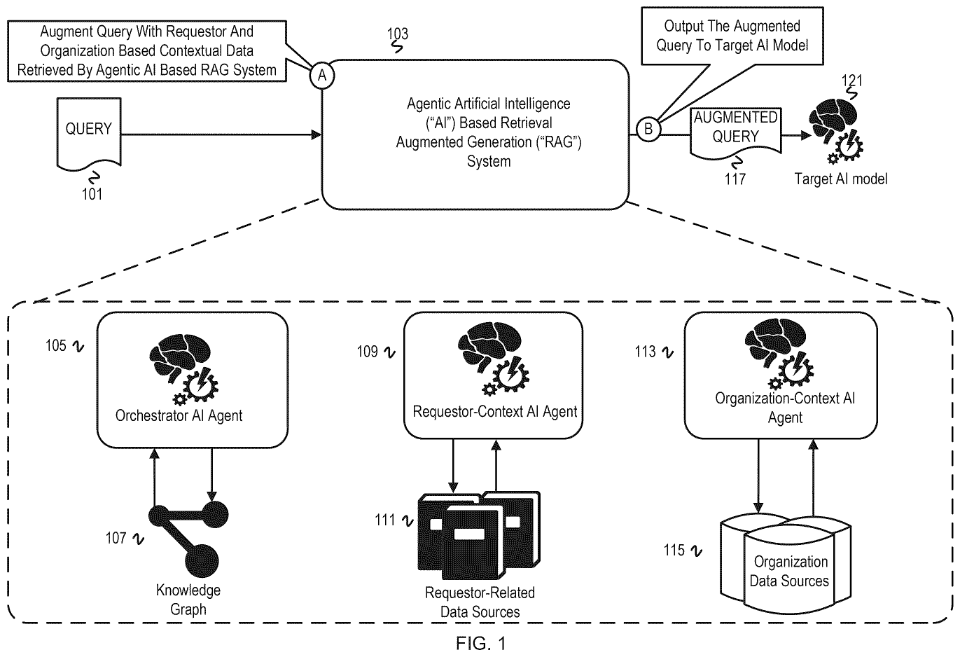

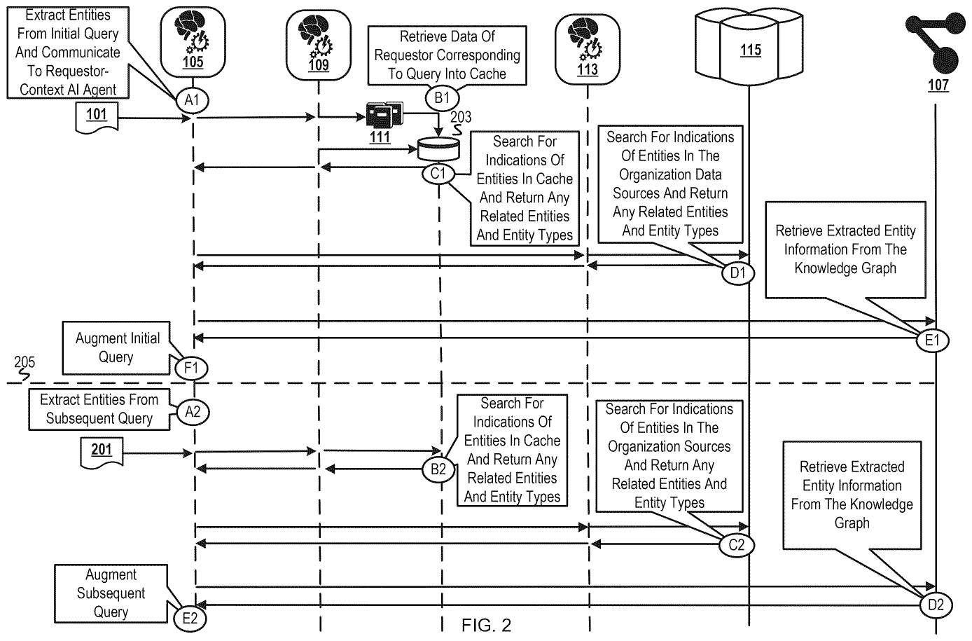

FIGS. 1-2 are example diagrams of an agentic AI RAG system receiving a query and augmenting the query with graph structured data from a knowledge graph. FIG. 1 depicts an example diagram of a query being augmented by an agentic AI based RAG system. The diagram includes an agentic AI based RAG system 103 that receives a query 101 to be augmented. The agentic AI based RAG system 103 encompasses an orchestrator AI agent (“orchestrator”) 105, knowledge graph 107, requestor-context AI agent 109, requestor-related data sources 111, an organization-context AI agent 113, and organization data sources 115. Agentic AI based RAG system 103 outputs an augmented query 117 to a target AI model 121.

FIG. 1 is annotated with a series of letters, A-B, representing stages of augmenting a query, each stage corresponding to one or more operations. Although these stages are ordered for this example, the stages illustrate one example to aid in understanding this disclosure and should not be used to limit the claims. Subject matter falling within the scope of the claims can vary from what is illustrated. At stage A, the query 101 is received by the agentic AI based RAG system 103 and augmented to include additional context for each entity present in the query 101. At stage B, the Agentic AI based RAG system 103 outputs the augmented query 117 to the target AI model 121.

The query 101 is a human-readable text input that indicates one or more entities. Examples of entities extracted from query 101 include “alert”, “data source”, “token”, “that development tool”, “the cloud instance”, “my data repository”, and “onboard”. The agentic AI based RAG system 103 includes AI agents that are used to extract entity information from relevant data sources of an organization. Each AI agent in the agentic AI based RAG system 103 contains memory, a tool, and a reasoning engine. The reasoning engines of the orchestrator 105, requestor-context AI agent 109, and organization-context AI agent 113, can be any foundation model.

The orchestrator 105 has access to the knowledge graph 107 for information retrieval. The knowledge graph 107 contains a graph of nodes that represent entities (“entity nodes”) that are connected to other entity nodes by directed edges that represent the corresponding relationship(s) between entity nodes (“relationship edges”). The requestor-context AI agent 109 has access to the requestor-related data sources 111 that encompass data collected about the requestor or the requestor activities. Examples of requestor-related data in the data sources 111 include requestor traffic logs, conversations with AI models, requestor API requests and responses, and service logs. Examples of the organization data sources 115 include repositories of cloud environment data for the organization, such as logs, account information, and code repositories.

FIG. 2 is a diagram of the agentic AI based RAG system retrieving information to augment an initial query and a subsequent query. In FIG. 2, the agentic AI based RAG system 103 augments the initial query 101, and a subsequent query 201. Processing of the initial query 101 is separated by a dashed line 205 from the processing of the subsequent query 201.

FIG. 2 is annotated with a series of letters, A1-F1 and A2-E2, representing stages of operations, each stage corresponding to one or more operations. Stages A1-F1 correspond to the processing of the initial query 101 of a requestor session. Stages A2-E2 correspond to the processing of the subsequent query 201 in the requestor session. Although these stages are ordered for this example, the stages illustrate one example to aid in understanding this disclosure and should not be used to limit the claims. Subject matter falling within the scope of the claims can vary from what is illustrated.

At stage A1, the orchestrator 105 extracts one or more entities from the initial query 101. The orchestrator 105 will extract entities from the initial query 101 using its reasoning engine which has named entity recognition capability. The orchestrator 105 will then communicate the extracted one or more entities to the requestor-context AI agent 109. In addition to the extracted entities, the orchestrator 105 will communicate a requestor identifier to the requestor-context AI agent 109. The orchestrator 105 can determine the requestor identifier from session information that is available in metadata of the initial query 101 or communicated to the orchestrator 105 from a front-end interface, for example.

At stage B1, the requestor-context AI agent 109 uses the requestor identifier to determine if the initial query 101 is the first query received from the requestor in this session. The requestor-context AI agent 109 will, after determining that this is the first query from the identified requestor in this session, retrieve, from requestor related data sources 111, requestor-related data corresponding to the requestor identifier. The requestor-context AI agent 109 will then load the requestor-related data into a cache 203. The requestor-related cache 203 is instanced per requestor and per requestor session.

At stage C1, the requestor-context AI agent 109 searches the requestor-related data stored in the cache 203 for an indication of entities and entity types that correspond to the extracted entities indicated by the orchestrator 105. The requestor-context AI agent 109 finds indications of entities and entity types, by using its reasoning engine to search through the requestor-related cache 203 for requestor references to the extracted entity and extracted entity types based on the natural language processing capabilities of the reasoning engine. Example references by the requestor to the extracted entities include API requests or responses that include the extracted entity, recent appearances of the extracted entity on the user interface (UI), and requestor conversations with AI models that include the entity. The requestor-context AI agent 109 will also search the cache 203 for an indication of the extracted entities' type. The requestor-context AI agent 109 searches for references by the requestor to the extracted entities to determine an extracted entity type (e.g. references by the requestor to an extracted entity containing multiple data objects or being of a certain size, indicates the extracted entity is a type of data storage). The requestor-context AI agent 109 will then return to orchestrator 105 the found entities and entity types of the extracted entities.

At stage D1, the orchestrator 105 communicates the extracted entities to the organization-context AI agent 113. The organization-context AI agent 113, for each of the organization data sources 115, will then iteratively perform lookup operations on each extracted entity to find an indication of the extracted entity and extracted entity types. The organization-context AI agent 113 will iteratively search the organization data sources 115 for each of the extracted entities. The orchestrator 105 may indicate the entities extracted by the orchestrator 105 and by the requestor-context AI agent 109. Implementations can instead reduce the entities passed to the organization-context AI agent 113 by filtering out the orchestrator extracted entities found by the requestor-context AI agent 109. The organization-context AI agent 113 has access to a tool configured to perform lookup operations on the organization data sources 115. The tool can be configured to use a software development kit, perform API calls, or search cloud-based resource search indexes. The organization-context AI agent 113 then returns the found entities and entity types of the lookup operations to the orchestrator 105.

At stage E1, for each entity indicated to the orchestrator 105, the orchestrator 105 queries the knowledge graph 107 to retrieve the graph structured data relevant to the entities. The orchestrator 105 determines whether sufficient entities have been identified with entity types for a productive query to the knowledge graph 107. Sufficiency can be defined with a threshold (a sufficient entity threshold). The sufficient entity threshold can be based on a percentage of entities found by the requestor-context AI agent 109 and organization-context AI agent 113 as compared to the number of the orchestrator 105 extracted entities. If the sufficient entity threshold is not met, the orchestrator 105 will generate indications for the entities that received no context from either the requestor-context AI agent 109 or the organization-context AI agent 113. If the interactions with the AI agents 109, 113 have yielded sufficient information, then the orchestrator 105 queries the knowledge graph 107 with the entities and entity types as parameters. Parameters for the graph query can also include a maximum degree of separation to retrieve information from the knowledge graph 107. Based on the query, the orchestrator 105 retrieves properties of the entity, properties of the related entities (neighbors), and information about the relationship between the entity and the neighbors. If no indication of the extracted entity was communicated by the requestor-context AI agent 109 and the organization-context AI agent 113, the orchestrator 105 will instead use the extracted entity and corresponding entity types to retrieve the extracted entity graph structured data from the knowledge graph 107.

At stage F1, the orchestrator 105 augments the initial query 101 with the graph structured data retrieved from the knowledge graph 107. The orchestrator 105 aggregates the query with the retrieved structured data, such as by concatenating the retrieved structured data with the query. An implementation can also generate embeddings from the query and the retrieved structured data.

At stage A2, orchestrator 105 receives the subsequent query 201 and extracts one or more entities from the subsequent query 201. The orchestrator 105 will then communicate the extracted one or more entities, and a requestor identifier, to the requestor-context AI agent 109.

At stage B2, the requestor-context AI agent 109 uses the requestor identifier to determine if the subsequent query 201 is the first query received from the requestor in this session. As the subsequent query 201 is not the first query, the cache 203 is already loaded with the requestor-related data sources 111 from stage B1. The requestor-context AI agent 109 therefore does not load data from the requestor-related data sources 111 into the cache 203 as depicted at stage B1. Instead, the requestor-context AI agent 109 uses the requestor identifier to search the cache 203 for an indication of the extracted entities from the subsequent query 201 and extracted entity types. The requestor-context AI agent 109 will then return to the orchestrator 105 the found entities and entity types of the extracted entities.

At stage C2, the orchestrator 105 communicates the extracted entities to the organization-context AI agent 113. The organization-context AI agent 113 iteratively searches for information about the extracted entities in the organization data sources 115. The organization-context AI agent 113 then returns the results to the orchestrator 105. As in the operations of stage C1, the orchestrator 105 can filter the orchestrator extracted entities based on the results from the requestor-context AI agent 109.

At stage D2, for each extracted entity, the orchestrator 105 accesses the knowledge graph 107 to retrieve the extracted entities' graph structured data. If there is a sufficiency criterion applied by the orchestrator 105, the orchestrator 105 will determine whether there are sufficient results from the AI agents 109, 113 and may also determine whether those results have high confidence. Embodiments may program the orchestrator 105 to filter out results from the AI agents 109, 113 with low confidence of relevance to the orchestrator extracted entities. The orchestrator 105 then retrieves structured data from the knowledge graph 107 based on the extracted entities, entity types, and indications of entities returned from the AI agents 109, 113.

At stage E2, the orchestrator 105 will augment the subsequent query 201 with the graph structured data retrieved from the knowledge graph 107.

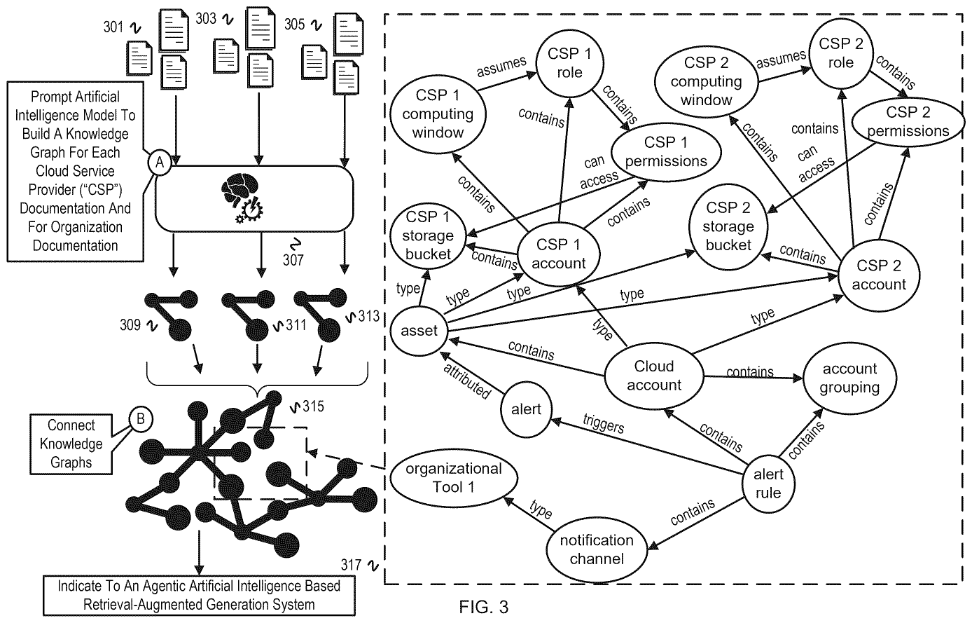

FIG. 3 is a diagram of an AI model generating a knowledge graph to be used by an agentic AI based RAG system. An AI model 307 has access to cloud service provider (“CSP”) documentation 301, CSP documentation 303, and organization documentation 305. The AI model 307 will generate knowledge graphs 309, 311, 313 and form a knowledge graph 315 by connecting the knowledge graphs 309, 311, 313.

CSP documentation 301 and CSP documentation 303 both represent separate CSP documentation for the respective CSP systems. Documentation refers to data in various formats and hosted in various sources (e.g., data lakes, data warehouses, data repositories, text files, HyperText Markup Language (HTML) documents, and comma-separated value files). The documentation may be locally hosted or remotely hosted. The CSP documentation 301, 303 document information about the resources, services, platforms, etc. of the corresponding CSP. The organization documentation 305 documents the cloud environments of the organization. Examples of CSP documentation 301 and CSP documentation 303 include developer logs, marketing material, web articles, and manuals of the CSP.

FIG. 3 is annotated with a series of letters A-B representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, a prompt is provided to the AI model 307 that includes or references a predefined domain taxonomy and ontology of the cloud environments of the organization and tasks to build a knowledge graph based on each of the documentations 301, 303, 305. The predefined taxonomy and ontology are context to guide entity extraction from the CSP documentation 301, CSP documentation 303, and the organization documentation 305. The predefined domain taxonomy and ontology has been defined with expert knowledge, although embodiments can employ generative AI. The task instructions in the prompt direct the AI model 307 to extract information about the entities and relationships based on the predefined taxonomy and ontology. Extraction of entities and relationships from the documentation 301, 303, 305 includes extraction of corresponding information. For instance, extraction of an entity “account” will include information about the account and the relationships will include permissions and actions. The extracted data may already be in the form of an object or table, or the prompt can include task instructions that specify a format. Example entity information that will be extracted and encoded into a representative node, either literally or referentially, when the graph is built includes documents, associated tables, APIs, location information, actions permitted on the entity or by the entity, and security information. Examples of relationship information that can be extracted and encoded into an edge include the relationship degree (e.g. one-to-one, one-to-many, or many-to-many), the position of the entity on a UI, and directionality of a relationship. The AI model 307 creates and stores data objects for the extracted information to be used in the graph building. Example types of data objects of the extracted entities and relationships include JavaScript® Object Notation (JSON) data objects. To build the knowledge graphs 309, 311, 313, the prompt or a chained prompt will include a task instruction(s) to build a graph that relates the extracted entities based on the defined taxonomy and ontology and extracted relationship information. The prompt or chained prompt can also include a constraint that specifies a query format and a graph database or technology for hosting the graph. For instance, the prompt can specify that Structured Query Language (SQL) queries or Cypher® queries be used. The AI model 307 builds CSP knowledge graph 309, CSP knowledge graph 311, and organization knowledge graphs 313 based on the data objects for the respective extracted entity nodes and relationship edges.

At stage B, AI model 307 connects knowledge graphs 309, 311, and 313 together into knowledge graph 315. For each CSP graph, and for each node in the CSP graphs, the AI model 307 connects the CSP entity nodes to the organization knowledge graph 313 entity nodes based on the predefined ontology. The connecting edges between the organization entity nodes and the CSP entity nodes receive edge labels (e.g. of “type”). The AI model 307, after connecting graph 315, then indicates the knowledge graph 315 for use by an agentic AI based RAG system.

Knowledge subgraph 317 illustrates a subgraph of the knowledge graph 315. In the knowledge subgraph 317, several organization entity nodes are created that represent cloud accounts, assets, and alerts from the organization knowledge graph 313. The organization cloud account entity node has a relationship edge to the organization asset entity node (e.g. labeled “contains”). The organization alert entity node also has a relationship edge to the organization asset (e.g. labeled “attributed”). In this example, several entity nodes from the knowledge graph 309 for a first CSP are created that have type relationship edges to several of the organization entity nodes. The entity nodes created for the first CSP knowledge graph 309 include a “CSP 1 storage bucket” node, “CSP 1 account” node, and “CSP 1 permissions” node. The CSP 1 account node has relationship edges to the CSP 1 permissions and CSP 1 storage bucket nodes labeled “contains”, with the CSP 1 permissions node having a relationship edge to the CSP 1 storage bucket node labeled “can access”. The organization asset node has a relationship edge to the CSP 1 storage bucket node, and to the CSP 1 account node labeled “type”. Similarly, the organization cloud account node is connected to the CSP 1 account node by a relationship edge labeled “type”.

The second CSP knowledge graph 311, for the purposes of this example, includes substantively similar entity nodes and relationship edges as the first CSP graph 309. The second CSP graph 311 contains entity nodes representing a CSP 2 “storage bucket”, CSP 2 “account”, and CSP 2 “permissions”. The CSP 2 account node has relationship edges to the CSP 2 permissions and CSP 2 storage bucket nodes labeled “contains”, with the CSP 2 permissions node having a relationship edge to the CSP 2 storage bucket node labeled “can access”. The organization asset node is connected to the CSP 2 storage bucket node and to the CSP 2 account node by relationship edges labeled “type”. The organization cloud account node only has a relationship edge to the CSP 2 account node labeled “type”.

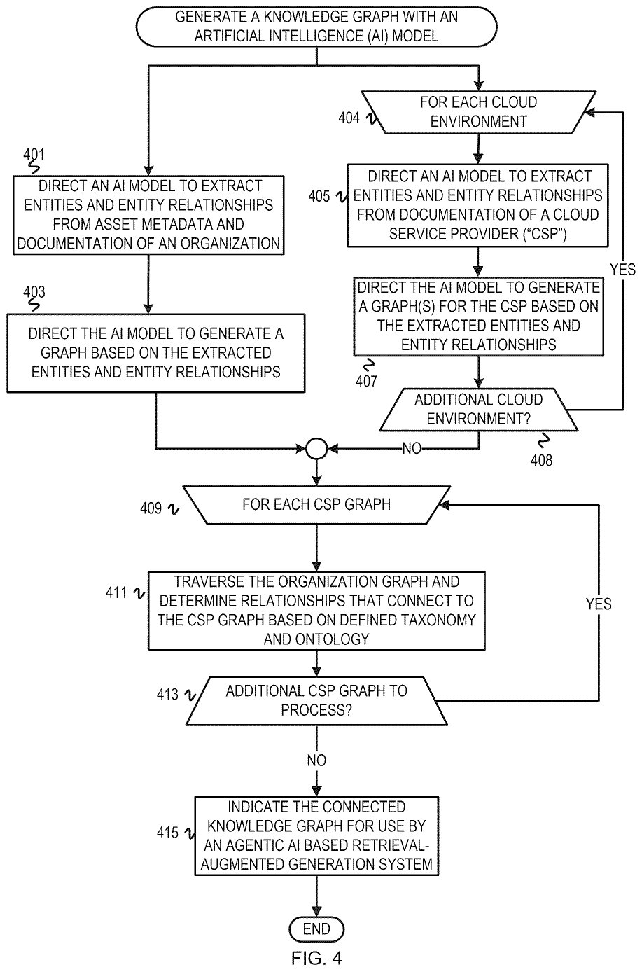

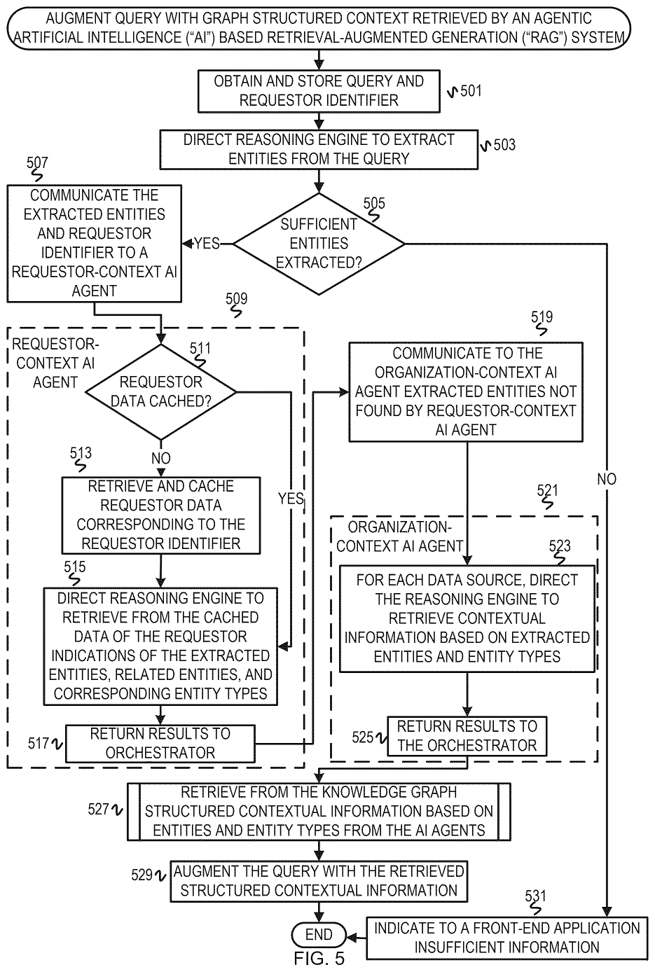

FIGS. 4-7 are flowcharts of example operations for agentic AI guided RAG. The example operations of FIG. 4 are described with reference to a graph constructor and the example operations of FIGS. 5-7 are described with reference to an agentic AI system and components of the agentic AI system for consistency with FIGS. 1-3 and ease of understanding. The name(s) chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 4 is a flowchart of example operations to generate a knowledge graph with an AI model. The agentic AI based RAG system uses a knowledge graph built in advance of deployment of the agentic AI based RAG system. The graph can be updated periodically or based on events (e.g., a threshold number of changes or addition of another CSP). As mentioned in the preceding paragraph, the example operations of FIG. 4 refer to a graph constructor as a moniker for the program code that directs a single AI model in constructing the graph. Building the graph can be adding entries into a database with structural information or generating a graph data structure. To direct the AI model, the graph constructor has access to prompt templates that are populated based on the task. The example operations are depicted as having a different execution path for building a graph from information extracted from documentation of an organization than the execution path for building a graph from information extracted from CSP documentation. In blocks 401, 403 the graph constructor directs an AI model to build the organization knowledge graph. In blocks 404, 405, 407, 408 the graph constructor directs the AI model to build each CSP specific graph. At block 409, the execution paths in the flowchart then converge for connecting the graphs to form the knowledge graph. Both execution paths can be performed in parallel or concurrently.

At block 401, the graph constructor directs an AI model to extract entities and entity relationships from asset metadata and documentation of an organization. The graph constructor prompts the AI model with a task instruction to extract entities and entity relationships from specified data sources. The graph constructor includes the predefined taxonomy and ontology in the prompt as context to guide the AI model in the entity extraction. The predefined taxonomy and ontology may be defined by expert knowledge and/or a domain expert or, at least partially, generated by an AI model. An implementation can direct the AI model to perform named entity recognition without including the predefined taxonomy and ontology as context in a prompt. The prompt provided to the AI model can also specify a format of output as part of extracting the entities. For example, the prompt may specify that each extracted entity and entity relationship is formatted according to a JSON object format specified in the prompt.

At block 403, the graph constructor directs the AI model to generate a graph based on the extracted entities and entity relationships. The graph constructor prompts the AI model to generate a graph based on the extracted entity information from block 401. This prompt includes the predefined ontology as context that constrains and guides graph building by defining the relationships of the entities. Taxonomy may also be included as context for graph building. Prompt templates can include task instructions dependent upon the technology used for encoding the structured information (i.e., the graph). For a graph that is encoded in a database, a prompt template includes unpopulated database queries for updating a database with entries for nodes and edges indicating relationships including queries to determine whether a node is already present in the database. The entity nodes of the constructed graph contain information that is based on the predefined taxonomy. Examples of information contained in the entity nodes include entity documents, associated tables and APIs, whether the entity is located on a UI, in an API, or in a database, what actions can be taken on an entity, the security of the entity, and how to secure the entity. The associated relationship edges of the entity nodes contain information based on the predefined ontology. Examples of information contained in the relationship edges include documents, contextual information of the entity, the degree of relationship (e.g. one-to-many, many-to-many), and the location of the entity on a user interface (UI). Embodiments can direct the AI model to construct the graph or build the graph with database commands or data structure functions as the AI model provides responses with extracted entity, entity types, and other entity information. Included below is an example prompt the graph constructor can use to direct the AI model to extract entities and build the organization knowledge graph:

“You are a knowledge graph constructor bot, your chief task is to read fresh documents and interface with a graph database to add/update/delete the knowledge already present in the graph database. You are provided with a few tools to interface with the database. Your job is to parse the input document and make sure the knowledge in the document has been updated in the knowledge graph. This involves checking any existing knowledge in the DB and checking if such existing knowledge is up to date with the latest refresh of the document or whether the knowledge is out of date.

The knowledge graph is organized in this format-node-entity type and their properties. This may be an external (cloud provider) entity or it may be an entity type present within our product domain or organization. The node will have details such as how to query this entity, where to find it on the UI, how to protect/secure this entity-edge-relationships between entities. The edge also contains metadata about the properties of the relationship and where to query the relational mappings in the databases, where to see it on the product UI

List of tools available to you:
1. add_node (node_json)
2. update_node (node_id, node_json)
3. delete_node (node_id)
4. add_edge (edge_json)
5. update_edge (edge_id, edge_json)
6. delete_edge (edge_id)
7. search (sql_string)—used to search for nodes or edges by name or by property

The commonly occurring entities in this product have been defined by a domain expert and arranged in this taxonomy:
<insert taxonomy here>

Here's the predefined ontology:
<insert ontology here>

Here is the new document to be parsed and ingested. If any of the entities or types in the taxonomy or ontology are mentioned in this document, be sure to adhere to the syntax and semantics defined above.
<insert document>

As part of a preprocessing step, another bot has already done a basic match to identify similar content in the knowledge graph. If this result set is empty, the document needs to be inserted for the first time (you need to break down the document into the entity type nodes and relationship edges, and invoke the ‘add’ document tool). If there are existing nodes and edges, review the existing information and compare it with the new data to see if it needs an update
<insert sql query result set>

### Output Format:

You need to give your output in a JSON format in an array consisting of invocations of different tools in order. You must also construct and supply the JSON payloads and parameters for the tool invocations

[ {″tool″: ″add_node″, parameters: [ {node json} ]}
{″tool″: ″update_node″, parameters: [ node_id, {node json} ]}
{ ″tool″: ″delete edge″, parameters: [ edge_id, {edge json} ]}
]”.

At block 404, the graph constructor begins processing the documentation of each CSP used by the organization. An organization will likely have accounts in multiple cloud environments offered by multiple CSPs. The graph constructor can query each of the published APIs of each CSP. The graph constructor will build a different graph for each CSP since each CSP can have different entities and relationships.

At block 405, the graph constructor directs the AI model to extract entities and entity relationships from the documentation of one or more CSPs. For each CSP, the graph constructor prompts the AI model with a task instruction to extract entities and entity relationships from specified data sources corresponding to the CSP documentation. To guide and/or constrain the extraction, the prompt can include as context the predefined taxonomy and can additionally include the predefined ontology. Similar to the extraction from the organization documentation, the prompt also can specify formatting for extracted information, such as the JSON format.

At block 407, the graph constructor directs the AI model to generate a graph(s) for the CSP based on the extracted entities and entity relationships. The graph constructor prompts the AI model to generate a graph based on the extracted information from the CSP documentation. This prompt includes the predefined ontology as context that constrains and guides graph building by defining the relationships of the entities. Taxonomy may also be included as context for graph building. Task instructions in the prompt template will correspond to the technology used for encoding the graph. The entity nodes of the constructed graph(s) contain information that is based on the predefined taxonomy. Examples of information contained in the entity nodes include entity documents, associated tables and APIs, location of the entity with respect to a UI, an API, or database, permitted actions for an entity, and security information of the entity. An example prompt the graph constructor can use to direct the AI model to generate the CSP specific graph can be formatted substantively the same as the example prompt described in block 403. The example prompt is not reiterated at this stage of operations for brevity.

At block 408, the graph constructor determines whether there is another CSP with documentation to process. If there is additional CSP documentation, then operational flow returns to block 404. Otherwise, operational flow proceeds to block 409.

At block 409, the graph constructor iterates over the CSP graphs to assemble the disparate graphs into a knowledge graph that relates the CSP agnostic entities of the organization with the CSP specific entities in the CSP graphs. A CSP graph of a current iteration is referred to as a currently selected CSP graph.

At block 411, the graph constructor traverses the organization graph and, while traversing, determines relationships that connect organization entity nodes to CSP entity nodes based on the predefined taxonomy and ontology. The graph constructor can use an AI model to connect the graphs, but the graph constructor does not necessarily use an AI model. For example, the graph constructor can access the predefined ontology based on a CSP agnostic entity of a visited node in the organization graph to determine which CSP entity in the currently selected CSP is a type of the CSP agnostic entity. When found, the graph constructor adds an edge relating the CSP agnostic entity node to the CSP entity node, for example with an edge label indicating that a CSP agnostic entity node is being related to a CSP entity node (e.g., “type”). As an example of using an AI model, the graph constructor can prompt the previously used AI model or another AI model to examine the extracted entities of the CSP and the extracted entities of the organization, determine correspondence between the CSP entities and CSP agnostic entities, and relate the corresponding node.

At block 413, the graph constructor determines whether there is another CSP graph to process. If there is another CSP graph to process, then operational flow returns to block 409. Otherwise, operational flow proceeds to block 415.

At block 415, the graph constructor indicates the knowledge graph for use by an agentic AI based RAG system. For example, the graph constructor can persist the knowledge graph to a location specified for the agentic AI based RAG system. As another example, the graph constructor passes the knowledge graph to the agentic AI based RAG system by reference, or by copy.

FIG. 5 is a flowchart of example operations to augment a query with graph structured context retrieved by an agentic AI based RAG system. The agentic AI based RAG system uses several AI agents, created in advance of a query, to augment the query with graph structured context. The graph structured context facilitates a more precise response from the AI model that responds to the query, because the structured information indicates relationships among relevant entities. The agentic AI based RAG system has access to the constructed knowledge graph, data sources with indications of users or principals, and data sources of the organization. The AI agents of the agentic AI based RAG system have access to prompt templates that are populated based on a corresponding task. The AI agents use the prompt templates to direct the reasoning engines associated with each AI agent to perform certain tasks. The agentic AI based RAG system can process multiple queries from separate requestors concurrently and are not instanced per requestor, or per query. The example operations of FIG. 5 refer to an orchestrator, requestor-context AI agent, and an organization-context AI agent. Each moniker is a representation of a primary task for the corresponding AI agent. Requestor is a moniker that can refer to a user, principal, or process that passes a query to the agentic AI based RAG system. While FIG. 5 depicts example operations for the collection of AI agents used in the system, a dashed line delineates the example operations for the different AI agents. Descriptions of the example operations will refer to the corresponding one of the orchestrator, the requestor-context AI agent, and the organization-context AI agent.

At block 501, the orchestrator obtains and stores a query and a requestor identifier. A user interface or front-end for the AI model that will respond to the query communicates the query to the orchestrator. The agentic AI based RAG system can be a layer in an AI stack or be a service accessed by an AI application for query augmentation. If the agentic AI based RAG system is integrated into an AI application (e.g., a layer in an AI/LLM stack), the agentic AI based RAG system can access session information to obtain the requestor identifier. If the agentic AI based RAG system does not or cannot access session information, the front-end system can communicate the requestor identifier to the orchestrator. The requestor identifier corresponds to both the requestor and the session that the query is related to.

At block 503, the orchestrator directs the reasoning engine to extract entities from the query. The orchestrator can use a prompt template that includes one or more instructions to task the reasoning engine to extract named entities from the query. The orchestrator can populate the prompt template with the query and then store the extracted entities generated by the reasoning engine of the orchestrator. Included below is an example prompt for directing the orchestrator associated reasoning engine:

“You are an entity extractor bot and you are part of a larger multi-agent AI system designed to answer queries about the organization product line of a specific organization. Your chief task is to extract entities from user queries so those entities can be looked up and additional context can be fetched about those entities to aid in responding to the user query.

### Instructions:

1. You need to extract both entity types as well as entity names
2. Entity types that are relevant to this AI system and Product domain, as well as frequently occurring entity types are provided below as part of a taxonomy and ontology defined by a domain expert. Be consistent with these.
3. You may use pattern matching to recognize some of the entity names and types for cloud entities. For example, CSP 1 typically follows naming conventions for cloud resources such as i-12345678 for virtual server instances, sg-12345678 for security groups, etc. Similarly, you may rely on common well-known patterns for other common cloud providers as well.

### Output Format

Your output should be a JSON comprising of “entity_names” and “entity_types” mentions in the user query. Inside the “entity_names” should be a nested JSON containing up to 2 fields-name of the entity and optionally type of the entity—where this entity_type of the entity name is implicit or apparent from the user query either based on context of the query or based on common naming patterns for that entity type.

sample output for user query—‘Can you tell me if i-12345678 can be accessed from vpc-1234567 and whether it has any cross-cloud access permissions to other CSP 2 projects’:

```
{
  ″entity_names″: [
    {″name″:″i-12345678″, ″entity_type″: ″CSP 1 virtual server
    instance″},
    {″name″:″vpc-1234567″, ″entity_type″: ″CSP 1 virtual private
    cloud instance”}
  ],
  ″entity_type″: [″permissions″, ″CSP 2 project″]}”.
```

At block 505, the orchestrator determines whether a sufficient number of entities were extracted. A threshold can be defined for sufficiency. The orchestrator compares the number of extracted entities to the predefined sufficient entity threshold. If the orchestrator determines that sufficient entities were extracted, then operational flow proceeds to block 507. Otherwise, operational flow continues to block 531.

At block 507, the orchestrator communicates the extracted entities and the requestor identifier to a requestor-context AI agent. Communication between the orchestrator to the other AI agents can be performed according to an AI agent monitoring paradigm. Under an AI agent monitoring paradigm, the orchestrator uses explicit communication with the AI agents (e.g., where an AI agent gives or receives explicit communication), monitors the AI agents, and waits for responses from the AI agents before initiating further action. The orchestrator can perform real-time monitoring of the AI agents by implementing AI agent performance tracing of events. The AI agents can also be configured to log activity updates. The orchestrator can then monitor the AI agent activity logs to determine the progress of the AI agents. The orchestrator can provide explicit communication by using predefined communication protocols of how the AI agents communicate with each other. The communication protocols can define what commands, feedback, requests, symbols, and definitions of the symbols the orchestrator and AI agents use to communicate with the other AI agents.

The orchestrator can also communicate to the other AI agents according to operations of a tool configured for a publisher-subscriber paradigm. Under a publisher-subscriber paradigm, the orchestrator and the other AI agents can have both publisher and subscriber roles to a shared repository. FIG. 5 depicts a dashed line 509 to delineate the example operations of the requestor-context AI agent. The dashed line 509 encompasses blocks 511, 513, 515, and 517.

At block 511, the requestor-context AI agent determines whether data corresponding to the requestor identifier has been cached already. Embodiments do not necessarily cache data of a requestor. However, a requestor will likely submit multiple queries to an AI model. Thus, the requestor-context AI agent can retrieve data corresponding to the requestor in response to an initial query of a session for efficiency in augmenting subsequent queries. The requestor-context AI agent can index or identify each cache by requestor identifier or a compact representation (e.g., hash value) of the requestor identifier. If the requestor-context AI agent determines that requestor data has been cached, then operational flow continues to block 515. If the requestor-context AI agent determines that the requestor data has not been cached, then operational flow continues to block 513.

At block 513, the requestor-context AI agent retrieves and caches requestor data corresponding to the requestor identifier. The requestor-context AI agent prompts the reasoning engine with one or more task instructions to retrieve data from data sources specified in the task instructions, or by using tools with the requestor-context AI agent. The requestor-context AI agent includes the requestor identifier or requestor metadata as context for the retrieval. Example data sources include historical logs, service logs, user monitoring tools, conversations the requestor had with AI models, logs of requestor accessed web pages, and API gateway logs of requestor requests to the API and the API responses. The API gateway can also monitor and log API requests and responses.

At block 515, the requestor-context AI agent directs its reasoning engine to retrieve, from the cached data of the requestor, indications of the extracted entities and corresponding entity types. The requestor-context AI agent can also direct the reasoning engine to extract related entities and corresponding entity types. The requestor-context AI agent can use a prompt that includes one or more task instructions for the extraction. The prompt will include as context the entities communicated from the orchestrator. The requestor-context AI agent can add a constraint to the prompt that directs the reasoning engine not to consider, or weigh less heavily, information in the requestor cache that has a date older than a predefined threshold date. The task instructions in the prompt can direct the reasoning engine to assign relevancy or confidence scores to each extracted entity and entity type. The prompt task instructions to the reasoning engine can include directions to generate multiple indications of each extracted entity. The confidence score can then be based on comparing the consistency of the generated indications to each other. Included below is an example prompt for directing the requestor-context AI agent to extract entities and corresponding entity types:

“You are an entity recognition bot and you are part of a larger multi-agent AI system designed to answer queries about the organization product line of a specific organization. Your chief task is to identify entity names from a user query that have been encountered before by the user. To aid with this, another bot in the system has performed data retrieval to find contextual information about the user's recent activity. You are supplied with the original user query, and the entity names or types that need to be resolved. You need to look at the following data sources to see if any of the entity names have been recently encountered before.

### Input:

1. User query is provided below
2. The entity names and types to be resolved from the user query are also provided below. The previous bot has also supplied a best guess for entity types for some of the entity and entity names, this might not be 100% accurate as the previous bot did not have all the context needed to make this determination.

```
{
  ″entity_names″: [
    {″name″:″i-12345678″, ″guessed_entity_type″: “CSP 1 virtual
    server instance″},
    {″name″:″10.23.10.14″, ″guessed_entity_type″: ″IPv4″}
    {″name″:″devtest-1912″},
    {″name″:″662266221445″}
  ],
  ″entity_type″: [″permissions″, ″CSP 2 project″]
}
```

3. As a preprocessing step, the system has also retrieved the 20 recent API requests triggered by this user and the responses from API gateway logs. These requests might have originated from the UI or from an API client using an API token. These logs might reference some of the entity_names from the latest user query. You need to review the request and response pairs to see if you can identify the entity type.

```
Output format:
{
  “matched_entity_names”: [
    {“name”:“i-12345678”, “entity_type”: “ CSP 1 virtual server instance”,
“match_source”: {“source_type”: “API_call”, “source_id”:“<request_id>” }},
    {“name”:“devtest-1912”, “entity_type”: “CSP 2 project”, “match_source”:
{“source_type”: “URL”, “source_id”:“<experience trace_id>”},
    {“name”:“662266221445”, “entity_type”: “CSP 1 Account”, “match_source”:
{“source_type”: “conversation_history”, “source_id”:“<conversation_id>”}
  ],
  “unmatched_entity_names: [
    {“name”:“10.23.10.14”, “guessed_entity_type”: “IPv4”}
  ],
  “entity_type”: [“permissions”, “CSP 2 project”]
}
```

The commonly occurring entities in this product have been defined by a domain expert and arranged in this taxonomy:
<insert taxonomy here>

Here's the predefined ontology:
<insert ontology here>

Here's the conversation between the user and AI so far, this includes the latest user query at the end:
<insert conversation history from current session and latest user query>

Here's a list of entity names to be resolved as identified by the previous bot
<insert entity names and types identified by orchestrator agent>

Here are the UI pages recently visited by the user. You may use query parameters in the URL to identify entities
<insert the recent 20 URLs collected from UI monitoring tool>

Here are the recent 20 API requests and responses performed by this user in the format [{“req”:“json”, “resp”:“json”}]:
<insert request & response pairs for this user>′

At block 517, the requestor-context AI agent returns the results to the orchestrator. The requestor-context AI agent can use a tool configured based on the AI agent communication protocols to communicate the entities to the orchestrator. Alternatively, the requestor-context AI agent can communicate the results to the orchestrator by having a requestor-context AI agent tool publish the entities to a repository shared with the orchestrator.

At block 519, the orchestrator communicates to the organization-context AI agent extracted entities not found by the requestor-context AI agent. The orchestrator determines based on the entity confidence scores what extracted entities to communicate to the organization-context AI agent. The orchestrator can use a tool configured based on the AI agent communication protocols to communicate the entities to the organization-context AI agent. Alternatively, the orchestrator can communicate the entities by publishing the entities to a repository shared with the organization-context AI agent. FIG. 5 depicts a dashed line 521 to delineate the example operations of the organization-context AI agent. The dashed line 521 encompasses blocks 523 and 525.

At block 523, the organization-context AI agent directs the reasoning engine to retrieve contextual information based on extracted entities and entity types from each data source. Data sources can be specified in configuration of the organization-context AI agent or be bound to a tool associated with the AI agent. The organization-context AI agent can also direct the reasoning engine to retrieve related entities and corresponding entity types. The organization-context AI agent can use a prompt that includes one or more task instructions for the retrieval. The prompt will include as context the entities communicated from the orchestrator. The prompt directs the reasoning engine to search the data sources of the organization for the extracted entity, related entities, and extracted entity types. The organization-context AI agent stores the entities returned by the reasoning engine. Examples of the data sources of the organization include tables, databases, and APIs that contain information and metadata regarding the cloud environment of the organization. Included below is an example prompt the organization-context AI agent uses to direct the associated reasoning engine:

“You are an entity recognition bot and you are part of a larger multi-agent AI system designed to answer queries about the organization product line of a specific organization. Your chief task is to resolve unidentified entity names from a user query. You need to do this by looking up entity names from the user query in the data sources accessible to the system. They have been defined below. Additionally, a domain expert has also defined a taxonomy and ontology comprised of the frequently occurring entity types in this domain and their relationships.

The commonly occurring entities in this product have been defined by a domain expert and arranged in this taxonomy:
<insert taxonomy here>

Here's the predefined ontology:
<insert ontology here>

Data sets accessible to the system.
1. Cloud entities—all entities in customer's cloud environments that have been scanned by the organization product line are stored in a central asset inventory table in a big query. The schema is supplied below. You may refer to the taxonomy to add filters based on asset_type or asset_class.
<insert DB schema for asset_inventory table>
2. Cloud account—the list of cloud accounts that have been onboarded by the customer onto the organization product line for monitoring. use the following API.
<insert API schema listing cloud accounts>
3. Account group—the groupings of accounts defined by the customer on organization product line. use the following API.
<insert API schema for listing account group>
4. Alerts—the alerts raised by organization product line use the following API.
<insert API schema for listing account group>

Tools available to you
1. request (**parameters)—can invoke an API request, construct an API query and supply the parameters. The syntax is the same as the python requests library.
2. big_query (sql_query)—pass an SQL string with the necessary filtering clauses to check if the entity_name exists in this dataset in big query database.
3. pg_query (sql_query)—pass an SQL string with the necessary filtering clauses to check if the entity_name exists in this dataset in PostgreSQL.

### Output Format:

One action at a time, if a query returns no results, then the entity name is not contained in the dataset, so try a different dataset to check if the entity name exists.

```
{
  “tool”: “request/big_query/pg_query”,
  “parameters”: [ ... ]
}
```

### Inputs:

Here are the entities after they've been processed by a contextual matcher bot which checks if any of those entities have been recently encountered. You also need to resolve the guessed types to confirm if they actually exist in the system.

```
{
  ″matched_entity_names″: [
    {″name″:″i-12345678″, ″entity_type″: ″CSP 1 virtual server instance″,
″match_source″: {″source_type″: ″API_call″, ″source_id″:″<request_id>″ }},
    {″name″:″devtest-1912″, ″entity_type″: ″CSP 2 project″, ″match_source″:
{″source_type″: ″URL″, ″source_id″:″<experience trace_id>″},
    {″name″:″662266221445″, ″entity_type″: ″CSP 1 Account″, ″match_source″:
{″source_type″: ″conversation_history″, ″source_id″:″<conversation_id>″}
  ],
  ″unmatched_entity_names: [
    {″name″:″10.23.10.14″, ″guessed_entity_type″: ″IPv4″}
    {″name″:″P-1345567″, ″guessed_entity_type″: ″Alert″}
    {″name″:″dev-secops-eu″}
    {″name″:″sg-123455″, ″guessed_entity_type″: ″security group″}
  ],
  ″entity_type″: [″permissions″, ″CSP 2 project″]
}”.
```

At block 525, the organization-context AI agent returns the results to the orchestrator. The organization-context AI agent can use a tool configured based on the AI agent communication protocols to communicate the entities and entity types to the orchestrator. Alternatively, the organization-context AI agent can use a tool to publish the stored entities and entity types to a repository shared with the orchestrator.

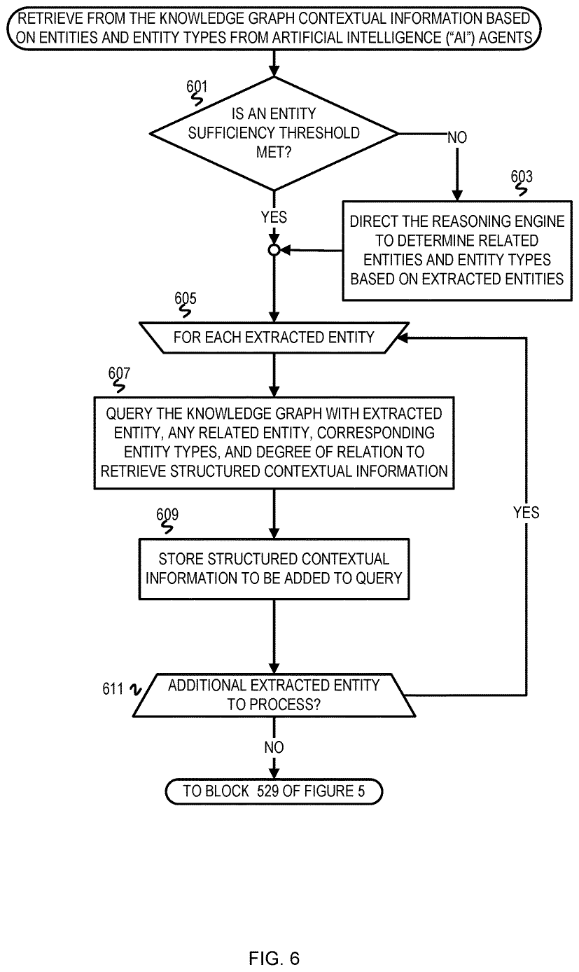

At block 527, the orchestrator retrieves from the knowledge graph structured contextual information based on the entities and entity types from the AI agents. The orchestrator uses the results from the AI agents to form a query to the knowledge graph. For instance, the orchestrator can use defined requests or function calls and populate the request/function with the entities and entity types. This operation is further described in FIG. 6.

At block 529, the orchestrator augments the query with the retrieved structured contextual information. For each entity extracted from the query, the orchestrator can communicate the retrieved entity information to a front-end application, or to a target AI model. For each entity, the structured contextual information can include the entity information, entities related to the entity within a defined degree of separation, properties of the entity, properties of the related entities, and information about the relationship between the entity and the related entities. The orchestrator can return the query augmented with structured contextual information to the front-end application. The front-end application can then communicate the query to the target AI model. Alternatively, the orchestrator can communicate the query augmented with structured contextual information directly to a target AI model.

If it was determined that the orchestrator extracted entities were not sufficient (e.g., too few entities or too few high confidence entities) at block 506, then the orchestrator indicates to the front-end that the query is insufficient (block 531). To indicate the insufficiency, the orchestrator can indicate to the front-end that the query requires clarification or additional context.

FIG. 6 is a flowchart of example operations to retrieve from the knowledge graph contextual information based on entities and entity types from the AI agents. The operations illustrated in FIG. 6 are example operations corresponding to block 527 of FIG. 5. The operations in FIG. 6 assume that the orchestrator has received entities that correspond to the extracted entities from the requestor-context AI agent and the organization-context AI agent.

At block 601, the orchestrator determines if an entity sufficiency threshold is met. The entity sufficiency threshold can be a predefined percentage of extracted entities that have no corresponding entities from the requestor-context AI agent and organization-context AI agent. The orchestrator compares the percentage of entities that do not have any corresponding entities to the predefined entity sufficiency threshold percentage. If the orchestrator determines that enough extracted entities have corresponding entities, then operational flow proceeds to block 605. Otherwise, operational flow continues to block 603.

At block 603, the orchestrator directs the reasoning engine to determine related entities and entity types based on extracted entities. The orchestrator can use a prompt that includes one or more task instructions to infer entity information, such as entity type and related entities, for those of the orchestrator extracted entities that received no responses from the requestor-context AI agent and organization-context AI agent.

Blocks 605, 607, 609, and 611 correspond to the execution flow for graph retrieval of entity structured contextual information from the knowledge graph. At block 605, the orchestrator begins iterating through each extracted entity.

At block 607, the orchestrator queries the knowledge graph with the extracted entity, any related entity, corresponding entity types, and degree of separation or distance to retrieve structured contextual information. The orchestrator can use program code to generate a graph query based on a graph query template and the entities returned by the requestor-context AI agent and the organization-context AI agent. Alternatively, the orchestrator can direct the reasoning engine to generate a graph query. The prompt to direct the reasoning engine will include, as context, the entities returned by the requestor-context AI agent and the entities returned by the organization-context AI agent. The orchestrator can then execute the generated graph query on the knowledge graph.

At block 609, the orchestrator stores structured contextual information to be added to query. The orchestrator stores the responses of the reasoning engine in memory. The reasoning engine can retrieve entity data, relationship data, and related entity data.

At block 611, the orchestrator determines whether there is another extracted entity to process. If there is an additional extracted entity, then operational flow returns to block 605. Otherwise, operational flow continues to block 529 of FIG. 5.

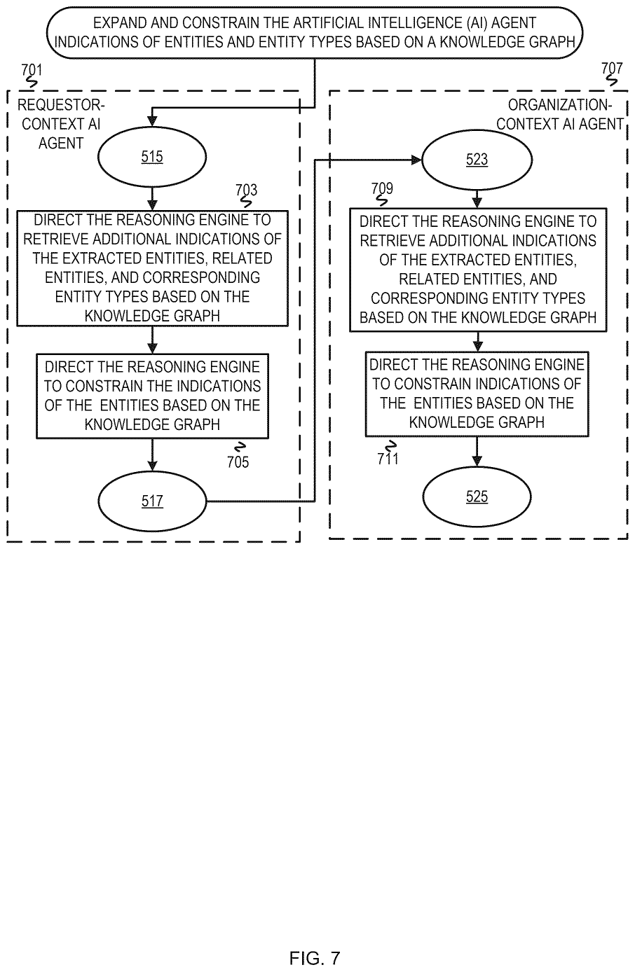

FIG. 7 is a flowchart of example operations to expand and constrain the AI agent indications of entities and entity types from an AI agent based on a knowledge graph. The operations illustrated in FIG. 7 are example operations of AI agents that direct the reasoning engines to retrieve indications of the extracted entities and entity types based on the knowledge graph. The respective reasoning engines are then directed to filter the retrieved indications based on the knowledge graph and extracted verb entities. In FIG. 7, the operations of block 703 continue from block 515 of FIG. 5 and the operations of block 709 continue from block 523 of FIG. 5. FIG. 7 depicts additional operations of an agentic AI based RAG system within the flow of operations depicted in FIG. 5.

FIG. 7 depicts a dashed line 701 to delineate the example operations of the requestor-context AI agent. The dashed line 701 encompasses blocks 703 and 705.

At block 703, the requestor-context AI agent directs the reasoning engine to retrieve additional indications of the extracted entities, related entities, and corresponding entity types based on the knowledge graph. The requestor-context AI agent prompts the reasoning engine using a prompt with one or more task instructions to retrieve indications of the extracted entities, related entities, and corresponding entity types from the knowledge graph. The prompt will include as context the extracted entities from the orchestrator. The prompt can include as context previous indications of the entities, related entities, and corresponding entity types from the requestor cache.

At block 705, the requestor-context AI agent directs the reasoning engine to constrain the indications of the entities based on results from accessing the knowledge graph. The requestor-context AI agent prompts the reasoning engine with one or more task instructions to filter the indications of the entities, related entities, and entity types based on the results from accessing knowledge graph. The prompt includes as context the indications of the entities, related entities, corresponding entity types, and extracted verb entities retrieved from the knowledge graph. Operational flow then proceeds to block 517 of FIG. 5.

FIG. 7 depicts a dashed line 707 to delineate the example operations of the organization-context AI agent. The dashed line 707 encompasses blocks 709, and 711.

At block 709, the organization-context AI agent directs the reasoning engine to retrieve additional indications of the extracted entities, related entities, and corresponding entity types based on the knowledge graph. The organization-context AI agent directs the reasoning engine using a prompt with one or more task instructions to retrieve indications of the extracted entities not in results of the requestor-context AI agent from the knowledge graph. The prompt includes as context the extracted entities from the orchestrator not in results from the requestor-context AI agent. The prompt can include as context the previous indications of the extracted entities generated by the organization-context AI agent.

At block 711, the organization-context AI agent directs the reasoning engine to constrain the indications of the entities, related entities, and corresponding entity types based on the knowledge graph. The organization-context AI agent prompts the reasoning engine with one or more task instructions to filter the entities extracted by the organization-context AI agent based on the data retrieved from the knowledge graph. The prompt includes as context the indications of the entities, related entities, corresponding entity types, and extracted verb entities retrieved from the knowledge graph. Operational flow then proceeds to block 525.

### Variations

Embodiments are not limited to the prompting described in the example illustrations. Embodiments can aggregate tasks into fewer prompts or decompose tasks into multiple prompts and can chain prompts.

Embodiments may also construct the knowledge graph differently than in the example illustrations. For instance, a graph constructor can sort the entity nodes in the connected knowledge graph into layers based on one or more configuration file(s). The one or more configuration files can include definitions of the layers and how to sort the entities of the connected knowledge graph into the layers (e.g., by sorting the entity nodes into “public” and “private” layers based on the sensitivity of the data therein).

In addition to variation in grouping of task instructions into one or more prompts, embodiments can vary in AI agent configuration/programming for interacting with its reasoning engine. The organization-context AI agent can direct the reasoning engine to search specified data sources using a predefined or generated order. The prompt to direct the reasoning engine can include one or more predefined configuration files containing an expert defined order for searching the specified data sources as a constraint. The prompt to the reasoning engine can include task instructions for the reasoning engine to generate an order to search the specified data sources and search the specified data sources based on the generated order. The prompt can include as context the extracted entities and one or more configuration files containing an expert defined order. The prompt to the reasoning engine can include a limit on the search of the specified data sources (e.g. a maximum number of specified data sources to search) per extracted entity as a constraint. Additionally, the organization-context AI agent can direct the reasoning engine with one or more task instructions to filter the extracted entities based on the graph and then search the specified data sources with a subset of the extracted entities. The prompt to direct the reasoning engine can include as context the indications of the available extracted entities separated into nouns and verbs, and the knowledge graph. The prompt to direct the reasoning engine can include task instructions to separate the extracted entities into nouns and verbs and filter the extracted nouns based on the knowledge graph and extracted verbs. Alternatively, the organization-context AI agent can include program code to separate the extracted nouns and verbs before prompting the reasoning engine with the extracted nouns, verbs, and knowledge graph as context.

Furthermore, architecture of the agentic AI based RAG system can vary. For example, the orchestrator, requestor-context AI agent, and the organization-context AI agent may have a common reasoning engine. The agentic AI based RAG system may eschew a third AI agent and assign the task of extracting information from organization data sources to either of the orchestrator or the requestor-context AI agent. Any of the AI agents may perform the task of extracting information from organization data sources with a tool or database defined functions instead of a reasoning engine.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations for constructing the CSP knowledge graphs depicted in FIG. 4 can be performed in parallel or concurrently instead of sequentially as depicted. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

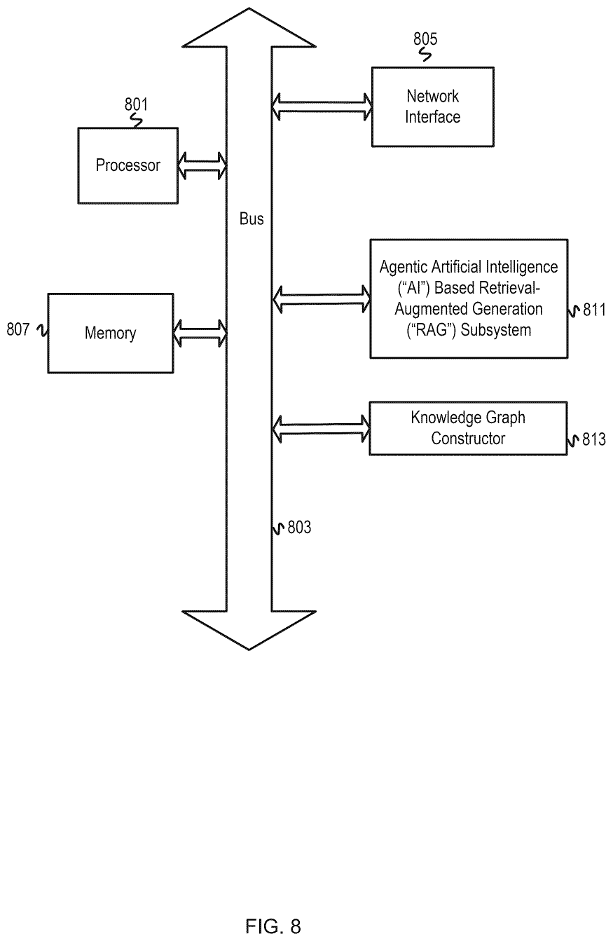

FIG. 8 depicts an example computer system with an agentic AI based RAG subsystem and a knowledge graph constructor. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes a knowledge graph constructor 813 and agentic AI based RAG subsystem 811. The knowledge graph constructor 813 directs an AI model to extract entities to build one or more knowledge graph(s) based on documentation of cloud environments specific to a CSP and CSP agnostic documentation for an organization corresponding to the cloud environments. The agentic AI based RAG subsystem 811 includes one or more AI agents that leverage the constructed knowledge graph and various data sources of the organization to augment queries. The AI agents of the agentic AI RAG subsystem 811 collect entity information that is related to the requestor of the query and to the organization but grounded to entities in the query. The agentic AI based RAG subsystem 811 then retrieves a subgraph(s) and the corresponding information of the nodes and edges from the knowledge graph. This information is structured according to the relationships encoded into the subgraph and provides greater context for the query due to the relationships and related entities being included. Any one of the previously described functionalities may be partially (or entirely) implemented in hardware and/or on the processor 801. For example, the functionality may be implemented with an application specific integrated circuit, in logic implemented in the processor 801, a co-processor on a peripheral device or card, etc. Further, realizations may include fewer or additional components not illustrated in FIG. 8 (e.g., graphics card, additional network interfaces, peripheral devices, etc.). The processor 801 and the network interface 805 are coupled to the bus 803. Although illustrated as being coupled to the bus 803, the memory 807 may be coupled to the processor 801.

### TERMINOLOGY

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
augmenting a query to a first artificial intelligence (AI) model with an agentic AI system and knowledge graph, wherein augmenting the query comprises,
extracting, by a first agent of the agentic AI system, a set of one or more entities from the query;
searching, by a second agent of the agentic AI system, requestor-related data for indication of the extracted entities and types of the extracted entities;
searching, by a third agent of the agentic AI system, a set of one or more data sources for indication of at least a subset of the extracted entities and corresponding entity types;
retrieving, by the first agent from the knowledge graph, structured context based on the extracted entities and types of the extracted entities returned by the second and third agents; and
augmenting the query with the structured context.

2. The method of claim 1 further comprising building, based on a plurality of documents, the knowledge graph to indicate a plurality of entities and relationships among the plurality of entities based on defined taxonomy and ontology for one or more knowledge domains corresponding to the plurality of documents.

3. The method of claim 2, wherein building the knowledge graph comprises building a first graph based on a first subset of the plurality of documents about resources that are either used or could be used by an organization and a second graph based on a second subset of the plurality of documents about one or more systems of the organization and connecting the first and second graphs form the knowledge graph.

4. The method of claim 2, wherein building the knowledge graph comprises prompting a second AI model, with the defined taxonomy and ontology as context and constraints, to extract entities and relationships among the entities from a first subset of the plurality of documents and prompting the second AI model or another AI model, with the defined taxonomy and ontology as context and constraints, to extract entities and relationships among the entities from a second subset of the plurality of documents, wherein the first subset of documents are about at least one of resources and cloud-based resources available to an organization and the second subset of documents are about at least one of systems and resources of the organization.

5. The method of claim 1 further comprising either the first agent or the second agent indicating the subset of extracted entities to the third agent, wherein the subset of extracted entities comprises those of the extracted entities either not found by the second agent or without sufficient confidence in results found by the second agent.

6. The method of claim 1 further comprising the second agent retrieving the requestor-related data based on requestor metadata associated with the query.

7. The method of claim 6, wherein retrieving the requestor-related data comprises the second agent searching one or more of historical dialogue logs, service logs, and user monitoring tools based on the requestor metadata.

8. The method of claim 1 constraining or contextualizing the searching with the graph by either of the second or third agent.

9. The method of claim 1, wherein the structured context comprises information retrieved from the knowledge graph about the extracted entities, related entities within a defined distance in the knowledge graph with at least one of the extracted entities, information about the related entities, and information about the relationships among the entities.

10. A non-transitory, machine readable medium having program code stored thereon, the program code comprising instructions to:
augment a query to a first artificial intelligence (AI) model with an agentic AI system and knowledge graph, wherein the instructions to augment the query comprise instructions to,
direct a first agent of the agentic AI system to extract a set of one or more entities from the query and to determine types of entities;
direct a second agent of the agentic AI system to search requestor-related data for indication of the extracted entities and to determine from the searching at least one of types of at least a subset of the extracted entities, entities related to the extracted entities and types of related entities;
direct the first agent to retrieve from the knowledge graph, structured context based on the extracted entities, types of the extracted entities, related entities, and types of the related entities; and
augment the query with the structured context.

11. The non-transitory, machine-readable medium of claim 10, wherein the instructions to direct the first agent of the agentic AI system to determine entity types further comprise instructions to direct the first agent to search a set of one or more data sources for the extracted entities and determine types of the extracted entities from descriptions of the extracted entities retrieved from the one or more data sources.

12. The non-transitory, machine-readable medium of claim 10, wherein the instructions to direct the first agent of the agentic AI system to determine types of entities comprise instructions to direct the first agent to determine types of the entities extracted from the query and types of related entities.

13. The non-transitory, machine-readable medium of claim 10, wherein the program code further comprises instructions to build, based on a plurality of documents, the knowledge graph to indicate a plurality of entities and relationships among the plurality of entities based on defined taxonomy and ontology for one or more knowledge domains corresponding to the plurality of documents.

14. The non-transitory, machine-readable medium of claim 13, wherein the instructions to build the knowledge graph comprise instructions to prompt a second AI model to build a first graph based on a first subset of the plurality of documents about resources that are either used or could be used by an organization and a second graph based on a second subset of the plurality of documents about one or more systems of the organization and to connect the first and second graphs based, at least in part, on the defined taxonomy and ontology.

15. The non-transitory, machine-readable medium of claim 10, wherein the instructions to direct the second agent to search requestor-related data comprise instructions to direct the second agent to search one or more of historical logs, service logs, and user monitoring tools based on the requestor metadata.

16. The non-transitory, machine-readable medium of claim 10, wherein the program code further comprises instructions to direct the second agent to constrain or contextualize the search of requestor-related data with the knowledge graph.

17. The non-transitory, machine-readable medium of claim 10, wherein the structured context comprises information about the extracted entities, related entities with a first-degree relationship in the knowledge graph with at least one of the extracted entities, information about the related entities, and information about the relationship among the entities.

18. An apparatus comprising:
a processor; and
a non-transitory machine-readable medium having instructions stored thereon, the instructions executable by the processor to cause the apparatus to:
augment a query to a first artificial intelligence (AI) model with an agentic AI system and knowledge graph, wherein the instructions to augment a query comprise instructions to,
direct a first agent of the agentic AI system to extract a set of one or more entities from the query and to determine types of entities;
direct a second agent of the agentic AI system to search requestor-related data for indication of the extracted entities and to determine from the searching at least one of types of at least a subset of the extracted entities, entities related to the extracted entities and types of related entities;
direct the first agent to retrieve structured context from the knowledge graph based on the extracted entities, types of the extracted entities, and the types of the related entities; and
augment the query with the structured context.

19. The apparatus of claim 18, wherein the non-transitory machine-readable medium further has stored thereon instructions executable by the processor to cause the apparatus to prompt a language model to build the knowledge graph, based on a plurality of documents, to indicate a plurality of entities and relationships among the plurality of entities based on defined taxonomy and ontology for one or more knowledge domains corresponding to the plurality of documents, wherein the instructions to prompt the language model to build the knowledge graph comprise instructions executable by the processor to cause the apparatus to prompt the language model to build a first graph based on a first subset of the plurality of documents about resources that are either used or could be used by an organization and a second graph based on a second subset of the plurality of documents about one or more systems of the organization and to connect the first and second graphs based, at least in part, on the defined taxonomy and ontology.

20. The apparatus of claim 18, wherein the non-transitory machine-readable medium further has stored thereon instructions to direct the second agent to constrain or contextualize the search of the requestor-related data with the knowledge graph.
